(19) United States
(12) Patent Application Publication
(10) Pub. No.: US 2007/0200480 A1
(43) Pub. Date: Aug. 30, 2007

(54) Method of recyclig fluorescent lamp

(76) Inventors: Joong-Hyun Kim, Gyeonggi-do (KR); Hyeon-Yong Jang, Gyeonggi-do (KR); Sang-Yu Lee, Gyeonggi-do (KR)

Correspondence Address: CANTOR COLBURN, LLP, 55 GRIFFIN ROAD SOUTH, BLOOMFIELD, CT, 06002, US

(21) Appl. No.: 10/585,172

(22) PCT Filed: Aug. 11, 2004
(86) PCT No.: PCT/KR04/02012

§ 371 Date: Jun. 30, 2006

(30) Foreign Application Priority Data
Dec. 31, 2003 (KR) 10-2003-0101388

(51) Int. Cl. H01J 1/62

(52) U.S. Cl. 313/493

(57) ABSTRACT

In an eco-friendly method of recycling a fluorescent lamp capable of reducing energy consumption and a recycling apparatus for performing the recycling method, broken pieces of fluorescent lamps are heated at a temperature of about 100? to about 330? to form a gas containing a mercury vapor. The gas containing the mercury vapor is cooled at a temperature of about −38? to about 0? to form a liquid mercury. The liquid mercury is collected. Therefore, the broken pieces of the fluorescent lamps are heated at the temperature no higher than the boiling point of mercury so that an energy consumption and a size of the recycling apparatus are decreased, and a probability for the recycling apparatus to malfunction may also be decreased.

### TECHNICAL FIELD

The present invention relates to a method of recycling a fluorescent lamp and a recycling apparatus for performing the method. More particularly, the present invention relates to an eco-friendly method of recycling a fluorescent lamp capable of reducing energy consumption and a recycling apparatus for performing the method.

### BACKGROUND ART

A predetermined voltage is applied to a mercury vapor so that a fluorescent lamp generates a light.

Energy consumption of the fluorescent lamp using the mercury vapor and an amount of heat generated from the fluorescent lamp are small, so that a flat display apparatus such as a liquid crystal display (LCD) apparatus employs the fluorescent lamp. Examples of the fluorescent lamp are an illumination lamp, a cold cathode fluorescent lamp (CCFL), an inner electrode fluorescent lamp (IEFL), an external electrode fluorescent lamp (EEFL), an external inner electrode fluorescent lamp (EIFL), a flat fluorescent lamp (FFL), etc.

The CCFL includes a fluorescent tube, the mercury vapor and a metal electrode. When a high voltage is applied to the metal electrode, a glow discharge occurs to the mercury vapor. An ultraviolet ray generated from the glow discharged mercury vapor passes through a fluorescent material disposed in the fluorescent tube so as to form a visible light.

The atomic weight of mercury (Hg) is 200.59, and the density of mercury is 13.5585. The melting point of mercury is −38.87° C., and the boiling point of mercury is 356.58° C. The density of mercury is 13.6 g/cm³. Mercury vapor of about 25 mg may be disposed in an air having a volume of about 1 m³ at a roam temperature.

Mercury is a poisonous pollutant. When a human body is exposed to an air containing mercury of about 0.1 mg/m³ for several years, the nerve system, liver, kidney, etc., may be damaged. Minamata disease was found in Minamata and Niikata, Japan, and 333 patients having the minamata disease had died. 459 patients who ate wheat containing organic mercury had died in Iran. In Republic of Korea, the Frame Work Act On Environmental Policy, the Industrial Safety And Health Act, etc., regulate the use of mercury. The World Health Organization (WHO) regulates that drinking water includes mercury no more than 0.001 mg/l. In addition, Japan, Australia, Europe, etc., regulate that a manufacturer of a mercury containing apparatus collects mercury back from the mercury containing apparatus.

Mercury may be collected through a fractional distillation.

In a process of collecting mercury through the fractional distillation, mercury is heated at a temperature greater than the boiling point so that a large amount of energy is consumed and the collected mercury may include impurities.

In addition, malfunction of the recycling apparatus using the fractional distillation may be increased and a size of the recycling apparatus may be increased due to a high temperature.

Furthermore, when a flow of a gas containing the mercury vapor corresponds to a turbulent flow, a yield of the collected mercury by the recycling apparatus may be decreased.

### DISCLOSURE OF INVENTION

### Technical Problem

The present invention provides an eco-friendly method of recycling a fluorescent lamp capable of reducing energy consumption.

The present invention also provides a recycling apparatus for performing the method.

### TECHNICAL SOLUTION

A method of recycling a fluorescent lamp in accordance with an aspect of the present invention is provided as follows. Broken pieces of fluorescent lamps are heated at a temperature of about 100° C. to about 330° C. to form a gas containing a mercury vapor. The gas containing the mercury vapor is cooled at a temperature of about −38° C. to about 0° C. to form a liquid mercury. The liquid mercury is collected.

A method of recycling a fluorescent lamp in accordance with another aspect of the present invention is provided as follows. Fluorescent lamps are broken using two rollers that rotate in opposite directions to each other. The broken pieces of the fluorescent lamps are collected under the rollers. The collected broken pieces of the fluorescent lamps are heated at a temperature of about 100° C. to about 300° C. to generate a gas containing a mercury vapor. The gas containing the mercury vapor is transported to a condensing part having a spiral shape having a spiral axis that is substantially parallel with a direction of gravitational force. The gas in the condensing part is cooled at a temperature of about −20° C. to about 0° C. to liquefy the mercury vapor. The liquid mercury is collected. A filter filters a remaining gas from which the liquid mercury is removed.

A method of recycling a fluorescent lamp in accordance with another aspect of the present invention is provided as follows. Fluorescent lamps are broken using two rollers that rotate in opposite directions to each other. Broken pieces of the fluorescent lamps are collected under the rollers. The collected broken pieces of the fluorescent lamps are heated at a temperature of about 100° C. to about 300° C. to generate a gas containing a mercury vapor. The gas containing the mercury vapor is transported to a heat exchanger so as to pre-cool the transported gas. The pre-cooled gas is transported to a condensing part having a spiral shape having a spiral axis that is substantially parallel with a direction of gravitational force. The gas is cooled in the condensing part at a temperature of about −20° C. to about 0° C. to liquefy the mercury vapor. The liquid mercury is collected. A remaining gas is transported from which the liquid mercury is removed to a heat exchanger. A filter filters the remaining gas that passes through the heat exchanger.

A recycling apparatus in accordance with one exemplary embodiment of the present invention includes a first collection container, a heater, a tubular unit, a cooler, a second collection container and a pump.

The first collection container collects broken pieces of the fluorescent lamps. The heater is disposed adjacent to the first collection container to heat the first collection container to form a gas containing a mercury vapor. The tubular unit includes a connecting part connected to the first collection container and a condensing part connected to the connecting part to have a spiral shape having a spiral axis that is substantially parallel with a direction of gravitational force, the tubular unit guiding the gas containing the mercury vapor. The cooler surrounds the condensing part to cool the gas in the condensing part to liquefy the mercury vapor. The second collection container is disposed under the condensing part to collect the liquid mercury. The pump is connected to the condensing part to aspirate the gas.

Therefore, the broken pieces of the fluorescent lamps are heated at the temperature no higher than the boiling point so that the energy consumption and a size of the recycling apparatus are decreased, and a probability of the recycling apparatus to malfunction may also be decreased. In addition, the pump includes the filter so that the remaining gas that passes through the filter may substantially not include mercury.

Furthermore, the recycling apparatus includes the condensing part and the heat exchanger so that a flow of the gas is a laminar flow, thereby decreasing energy consumption.

### BRIEF DESCRIPTION OF THE DRAWINGS

The above and other advantages of the present invention will become readily apparent by reference to the following detailed description when considered in conjunction with the accompanying drawings wherein:

FIG. 1 is a schematic view showing a recycling apparatus in accordance with an exemplary embodiment of the present invention;

FIG. 2 is a flow chart showing a method of recycling a fluorescent lamp in accordance with an exemplary embodiment of the present invention;

FIG. 3 is a flow chart showing a method of recycling a fluorescent lamp in accordance with another exemplary embodiment of the present invention;

FIG. 4 is a schematic view showing a recycling apparatus in accordance with another exemplary embodiment of the present invention;

FIG. 5 is a schematic view showing a recycling apparatus in accordance with another exemplary embodiment of the present invention;

FIG. 6 is a flow chart showing a method of recycling a fluorescent lamp in accordance with another exemplary embodiment of the present invention;

FIG. 7 is a flow chart showing a method of recycling a fluorescent lamp in accordance with another exemplary embodiment of the present invention;

FIG. 8 is a schematic view showing a recycling apparatus in accordance with another exemplary embodiment of the present invention;

FIG. 9 is a schematic view showing a recycling apparatus in accordance with another exemplary embodiment of the present invention; and

FIG. 10 is a graph showing a relationship between a saturation vapor pressure of mercury and a temperature.

### BEST MODE FOR CARRYING OUT THE INVENTION

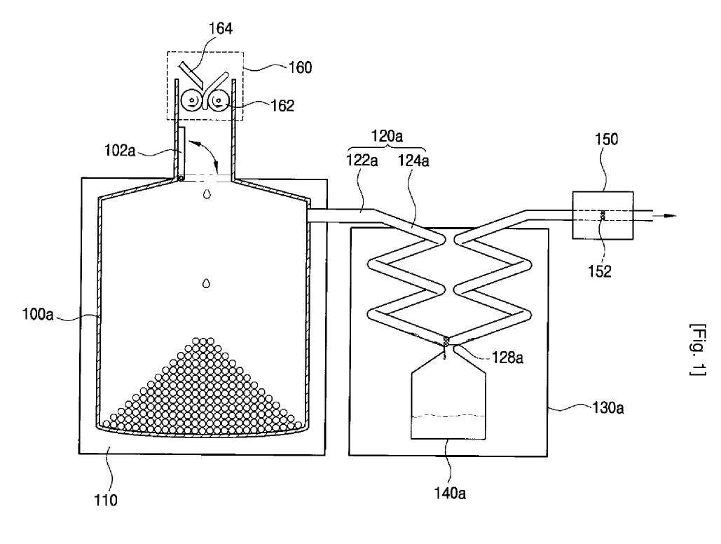

FIG. 1 is a schematic view showing a recycling apparatus in accordance with an exemplary embodiment of the present invention.

Referring to FIG. 1, the recycling apparatus includes a breaker 160, a first collection container 100a, a cover 102a, a heater 110, a tubular unit 120a, a cooler 130a, a second collection container 140a and a pump 150.

The breaker 160 includes a plurality of rollers 162 and a blower 164. The breaker 160 may have two rollers 162. The rollers 162 rotate in opposite directions to each other so that the rollers 162 break fluorescent lamps that are provided from the upper portion of the breaker 160. The broken pieces of the fluorescent lamps are collected in the first collection container 100a. When a distance between the outer surfaces of the rollers 162 is greater than about 5 cm, a size of each of the broken pieces of the fluorescent lamps is big so that an evaporation of a mercury on the broken pieces of the fluorescent lamps may be difficult. The distance between the outer surfaces of the rollers 162 may be no greater than about 5 cm. Alternatively, the distance between the outer surfaces of the rollers 162 may be adjusted in response to the size of each of the fluorescent lamps.

The blower 164 is disposed over the rollers 162 to guide the air adjacent to the rollers 162 toward the first collection container 100a. The blower 164 glides the gas ejected from the broken pieces of the fluorescent lamps and particles of the broken pieces of the fluorescent lamps toward the first collection container 100a.

The first collection container 100a is disposed under the breaker 160. The first collection container 100a includes an upper opening and a side opening. The upper opening corresponds to the upper surface of the first collection container 100a, and the side opening is disposed in a sidewall of the first collection container 100a. The upper portion of the first collection container 100a has a cylindrical shape. For example, a diameter and a height of the first collection container 100a are about 1 m. The upper surface of the first collection container 100a has a conical shape so as to collect the broken pieces of the fluorescent lamps dropped from the breaker 160. When the diameter and height of the first collection container 100a are about 1 m, the first collection container 100a may receive the broken pieces of about 200 fluorescent lamps, which is about 4 kg. The size and the shape of the first collection container 100a may be changed.

The first collection container 100a includes ceramic, iron, stainless steel, etc., so that the inner surface of the first collection container 100a may not be reacted with a fluorescent material, mercury, glass, etc., that are evaporated from the broken pieces of the fluorescent lamps.

The cover 102a is disposed on the first collection container 100a so as to open and close the upper opening corresponding to the upper portion of the first collection container 100a. The cover 102a is opened during the breaking of the fluorescent lamps, and the cover 102a is closed during the heating of the broken pieces of the fluorescent lamps to prevent a backflow of the gas having mercury. The cover 102a may include a valve guiding an air that is provided from an exterior into the first collection container 100a.

The heater 110 is disposed adjacent to the first collection container 100a to heat the first collection container 100a and the broken pieces of the fluorescent lamps disposed in the first collection container 100a. The heater 110 may be an electric heater. The heater 110 surrounds the first collection container 100a so as to heat the first collection container 100a at a temperature no lower than about 356.66° C. that is the boiling point of mercury. When the first collection container 100a is heated at a temperature higher than the boiling point, lifetime of the first collection container 100a is decreased and the evaporated gas may include impurities such as fluorescent material. The heater 110 may heat the first collection container 100a at a temperature of about 100° C. to about 300° C. Alternatively, the heater 110 may directly heat the broken pieces of the fluorescent lamps using an electromagnetic radiation.

The tubular unit 120a includes a connecting part 122a and a condensing part 124a. The tubular unit 120a glides the gas generated in the first collection container 100a into the second collection container 140a and the pump 150.

The connecting part 122a is connected to the sidewall of the first collection container 100a. The connecting part 122a corresponds to the side opening. The condensing part 124a is connected to the connecting part 122a, and has a spiral shape having a spiral axis that is substantially parallel with a direction of gravitational force so that a liquid mercury moves downwardly. The diameter of the connecting part 122a is no less than that of the condensing part 124a. Two spiral tubes may be parallelly connected to form a U-shaped condensing part 124a. The surface of the connecting part 122a and the condensing part 124a may also include recesses and protrusions so as to increase thermal conductivity. The diameter of the condensing part 124a may be no greater than about 1 mm, and a length of the condensing part 124a may be no greater than about 50 cm

The cooler 130a surrounds the condensing part 130a so as to cool the condensing part 124a and the gas disposed in the condensing part 124a. When the gas in the condensing part 124a is cooled, a saturation vapor pressure of mercury is decreased so that the mercury vapor disposed in the condensing part 124a is liquefied. The cooler 130a cools the condensing part 124a at a temperature of about −38.86° C. that is the melting point of mercury to about 0° C. When the condensing part 124a is cooled at a temperature less than about −38.86° C., a solidified mercury may be attached to the inner surface of the condensing part 124a to prevent a flow of the gas and the collection of the liquid mercury. The cooler 130a may cool the condensing part 124a at the temperature of about −20° C. to about 0° C. The liquid mercury is collected by a difference between the saturation vapor pressures corresponding to the temperature of the first collection container 100a and the temperature of the cooler 130a.

The second collection container 140a is disposed under the cooler 124a to collect the liquid mercury. The liquid mercury moves downwardly from the condensing part 124a into the second collection container 140a by the gravitational force.

A metal sieve 128a may be disposed in the condensing part 124a corresponding to the second collection container 140a so as to easily collect the liquid mercury.

The pump 150 is connected to the condensing part 124a to aspirate the gas from which the liquid mercury is removed. A specific capacity of the pump 150 may be no more than about 1001/min so that the gas flow corresponds to a laminar flow. Alternatively, the specific capacity of the pump 150 may also be about 201/min. Alternatively, the pump 150 may include a rotary pump.

The pump 150 includes a filter 152 filtering the gas from the tubular unit 120. An activated carbon, cotton filter, etc., may be used as the filter 152.

When the pump 150 is operated, an air is provided from an exterior to the first collection container 100a through a gap between the cover 102a and the upper opening corresponding to the upper portion to sequentially pass the first collection container 100a, the tubular unit 120a and the pump 150. The pump 150 aspirates in the lower flow rate of about 201/min so that the air is sufficiently heated in the first collection container 100a. The gas is ejected from the pump 150 having the filter 152.

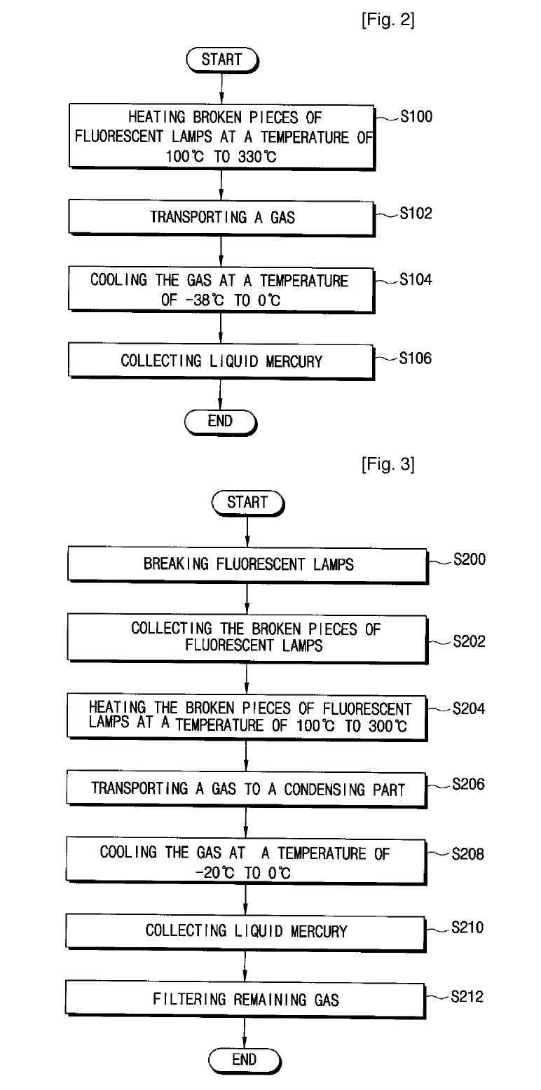

FIG. 2 is a flow chart showing a method of recycling a fluorescent lamp in accordance with an exemplary embodiment of the present invention.

Referring to FIG. 2, in step S100, the broken pieces of the fluorescent lamps are heated at a temperature of about 100° C. to about 330° C. to generate the gas containing the mercury vapor. The broken pieces of the fluorescent lamps are heated at the temperature no higher than the boiling point of mercury.

In step S102, the gas containing the mercury vapor is transported from the broken pieces of the fluorescent lamps by a predetermined distance. The gas may be transported through a metal tube.

In step S104, the transported gas is cooled at the temperature of about −38° C. to about 0° C. to form the liquid mercury. The transported gas is cooled at the temperature no lower than the melting point of mercury.

In step S106, the liquid mercury is collected.

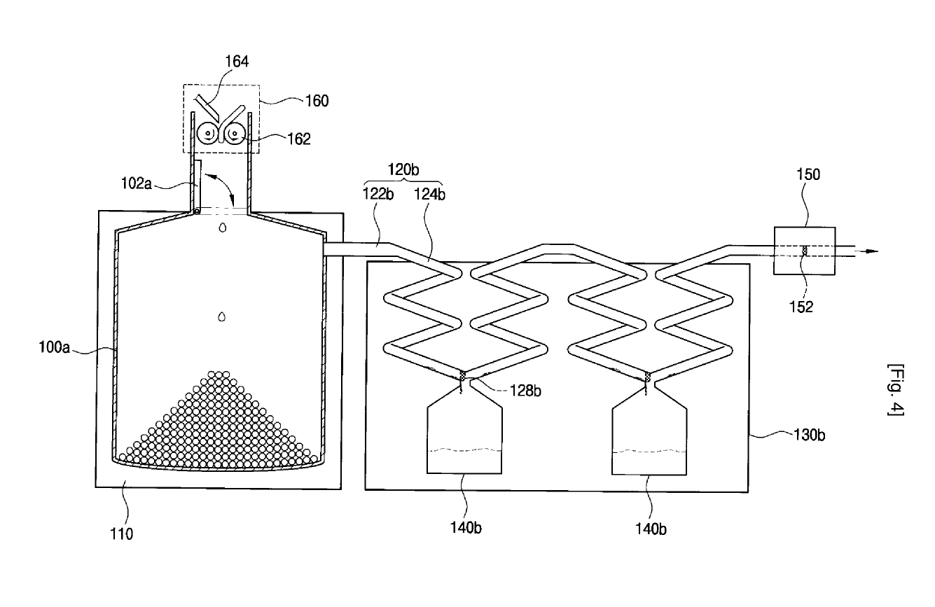

FIG. 3 is a flow chart showing a method of recycling a fluorescent lamp in accordance with another exemplary embodiment of the present invention.

Referring to FIGS. 1 and 3, in step S200, the rollers 162 rotate in opposite directions to each other to break the fluorescent lamps that are provided from the upper portion of the breaker 160. The cover 102a is opened during the breaking of the fluorescent lamps. A frictional force between the fluorescent lamps and the outer surface of the rollers 162 forms a compression stress to break the fluorescent lamps disposed between the rollers 162. The blower 164 guides the gas ejected from the broken pieces of the fluorescent lamps and particles of the broken pieces of the fluorescent lamps toward the first collection container 100a during the breaking of the fluorescent lamps.

In step S202, the first collection container 100a disposed under the rollers 162 collects the broken pieces of fluorescent lamps.

The cover 102a is closed so as to prevent the backflow of the gas containing mercury. The air may be provided from the exterior to the first collection container 100a through the gap between the cover 102a and the upper opening corresponding to the upper portion of the first collection container 100a.

In step S204, the collected broken pieces of fluorescent lamps are heated at a temperature of about 100° C. to about 300° C. to form the gas containing the mercury vapor. The broken pieces of fluorescent lamps are heated at a temperature no higher than the boiling point of mercury. When the broken pieces of the fluorescent lamps are heated at a temperature higher than the boiling point of mercury, the inner surface of the first collection container 100a may be reacted with the gas in the first collection container 100a so that the inner surface of the first collection container 100a may be polluted and the impurities may be evaporated with the mercury on the broken pieces of the fluorescent lamps. The gas is a mixture of the externally provided air and the mercury vapor.

The pump 150 is operated while the first collection container 100a is heated at the temperature of about 100° C. to about 300° C. so that the gas containing the mercury vapor is glided into the connecting part 122a. The externally provided air maintains the pressure in the first collection container 100a. The pump may be operated for a period of about one hour so that substantially all of the mercury in the first collection container 100a is removed.

In step S206, the gas in the connecting part 122a is guided toward the condensing part 124a. In order to increase surface area of the condensing part 124a, the diameter of the condensing part 124a is smaller than that of the connecting part 122a, and the condensing part 124a has the spiral shape having a spiral axis that is substantially parallel with a direction of gravitational force.

In step S208, the gas in the condensing part 124a is cooled at a temperature of about −20° C. to about 0° C. to liquefy the mercury vapor. The liquid mercury moves downwardly so that the liquid mercury is collected in the second collection container 140a disposed under the condensing part 124a. The metal sieve 128a is disposed in the condensing part 124a corresponding to the second collection container 140a to guide the liquid mercury into the second collection container 140a.

In step S210, the second collection container 140a collects the liquid mercury.

The filter 152 of the pump 150 filters a remaining gas from which the liquid mercury is removed.

According to the present embodiment, the broken pieces of the fluorescent lamps are heated at a temperature no higher than the boiling point of mercury, and the recycling apparatus includes the condensing portion 124a to reduce energy consumption. In addition, the pump 150 includes the filter 152 so that the remaining gas that passes through the filter may substantially not include mercury.

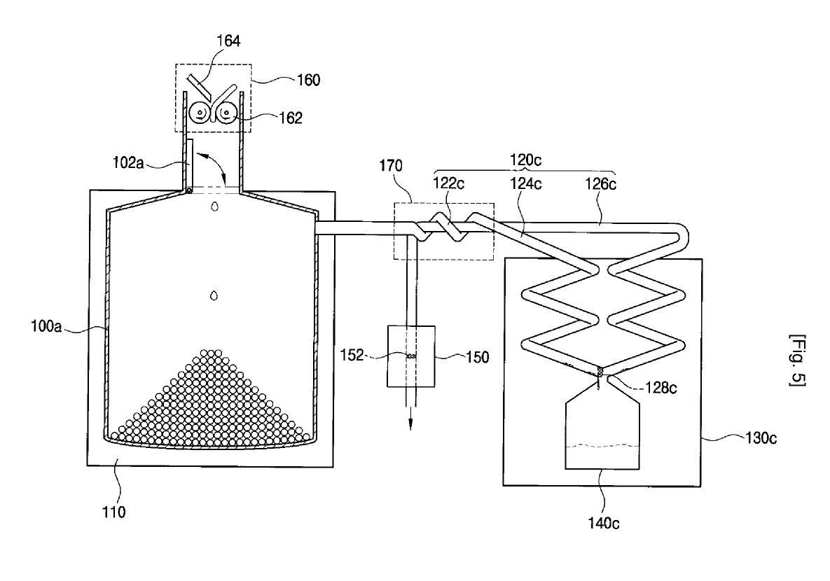

FIG. 4 is a cross-sectional view showing a recycling apparatus in accordance with another exemplary embodiment of the present invention.

The recycling apparatus of FIG. 4 is same as in FIG. 1 except for a second collection container. Thus, the same reference numerals will be used to refer to the same or like parts as those described in FIG. 1 and any further explanation will be omitted.

Referring to FIG. 4, the recycling apparatus includes a breaker 160, a first collection container 100a, a cover 102a, a heater 110, a tubular unit 120b, a cooler 130b, two second collection containers 140b and a pump 150.

The tubular unit 120b includes a connecting part 122b and a condensing part 124b so as to guide a gas generated in the first collection container 100a into the second collection containers 140b and the pump 150.

The connecting part 122b is connected to a sidewall of the first collection container 100a, and the connecting part 122b corresponds to a side opening of the first collection container 100a. The condensing part 124b is connected to the connecting part 122b, and has a spiral shape having a spiral axis that is substantially parallel with a direction of gravitational force so that liquid mercury moves downwardly. Four spiral tubes are parallelly connected to form a W-shaped condensing part 124b. A diameter of the condensing part 124b may be no greater than about 1 mm, and a length of the condensing part 124b may be no greater than about 1 m

The cooler 130b surrounds the condensing part 124b so as to cool the condensing part 124b and the gas in the condensing part 124b.

The second collection containers 140b are disposed under the cooler 124b to collect the liquid mercury. The liquid mercury moves downwardly from the condensing part 124b into the second collection containers 140b by the gravitational force.

Two metal sieves 128b may be disposed in the condensing part 124b corresponding to the second collection containers 140b so as to easily collect the liquid mercury.

Therefore, the length of the condensing part 124b is increased and the recycling apparatus includes two second collection containers 140b so as to improve a yield of the collected mercury by the recycling apparatus.

FIG. 5 is a cross-sectional view showing a recycling apparatus in accordance with another exemplary embodiment of the present invention.

The recycling apparatus of FIG. 5 is same as in FIG. 1 except for a heat exchanging part. Thus, the same reference numerals will be used to refer to the same or like parts as those described in FIG. 1 and any further explanation will be omitted.

Referring to FIG. 5, the recycling apparatus includes a breaker 160, a first collection container 100a, a cover 102a, a heater 110, a tubular unit 120c, a cooler 130c, a second collection container 140c and a pump 150.

The tubular unit 120c includes a connecting part 122c, a condensing part 124c and a heat exchanging part 126c so as to guide a gas generated in the first collection container 100a into the second collection containers 140c and the pump 150.

The connecting part 122c is connected to a sidewall of the first collection container 100a so as to guide a gas in the first collection container 100a into the condensing part 124c.

The condensing part 124c is connected to the connecting part 122c, and has a spiral shape having a spiral axis that is substantially parallel with a direction of gravitational force so that a liquid mercury moves downwardly by the gravitational force.

The heat exchanging part 126c is disposed between the condensing part 124c and the pump 150, and disposed adjacent to the connecting part 122c so as to pre-cool the gas in the connecting part 122c.

The connecting part 122c and the heat exchanging part 126c form a heat exchanger 170.

The cooler 130c surrounds the condensing part 124c so as to cool the condensing part 124c and the gas in the condensing part 124c. When the gas in the condensing part 124c is cooled, a saturation vapor pressure of mercury is decreased so that the mercury vapor disposed in the condensing part 124c is liquefied.

The second collection containers 140c are disposed under the cooler 124c to collect the liquid mercury.

A metal sieve 128c may be disposed in the condensing part 124c corresponding to the second collection container 140c so as to easily collect the liquid mercury.

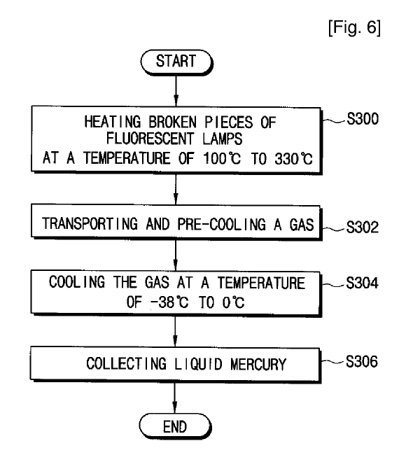

FIG. 6 is a flow chart showing a method of recycling a fluorescent lamp in accordance with another exemplary embodiment of the present invention.

Referring to FIG. 6, in step S300, the broken pieces of the fluorescent lamps are heated at a temperature of about 100° C. to about 330° C. so as to generate the gas containing the mercury vapor. The temperature for heating the broken pieces of the fluorescent lamps is no higher than the boiling point of mercury.

In step S302, the gas containing the mercury vapor is transported from the broken pieces of the fluorescent lamps by a predetermined distance while the gas containing the mercury vapor is pre-cooled using a cooled gas.

In step S304, the pre-cooled gas is cooled at a temperature of about −38° C. to about 0° C. so as to form the liquid mercury.

In step S306, the liquid mercury is collected.

A remaining gas from which the liquid mercury is removed is transported adjacent to the gas containing the mercury vapor so as to pre-cool the gas containing the mercury vapor.

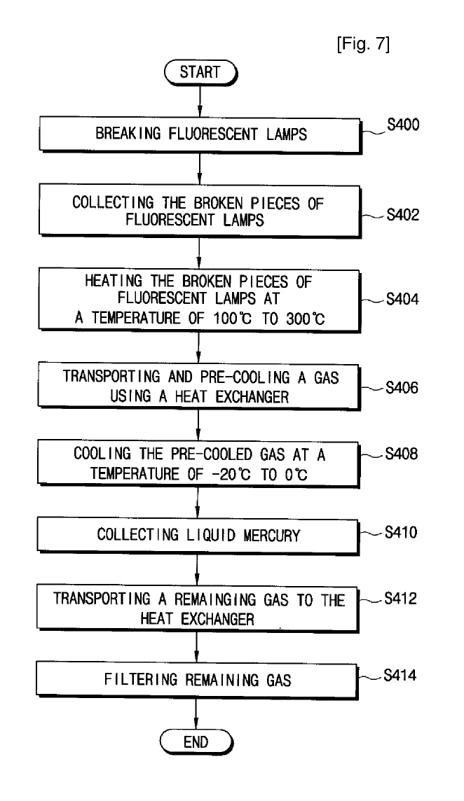

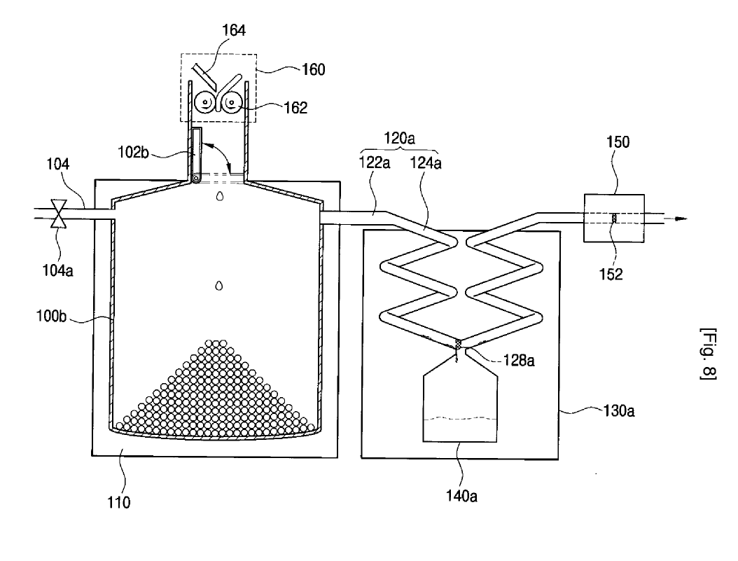

FIG. 7 is a flow chart showing a method of recycling a fluorescent lamp in accordance with another exemplary embodiment of the present invention.

Referring to FIG. 7, the rollers 162 rotate in opposite directions to each other so as to break the fluorescent lamps that are provided from the upper portion of the breaker 160, in step S400.

In step S402, the first collection container 100a disposed under the rollers 162 collects the broken pieces of the fluorescent lamps using a gravitational force.

In step S404, the collected broken pieces of the fluorescent lamps are heated at a temperature of about 100° C. to about 300° C. so as to form the gas containing the mercury vapor.

In step S406, the pump 150 is operated so that the gas containing the mercury vapor is guided into the connecting part 122c of the heat exchanger 170 and pre-cooled, while the first collection container 100a is heated at a temperature of about 100° C. to about 300° C.

In step S408, the gas in the connecting part 122c is guided into the condensing part 124c, and cooled at a temperature of about −20° C. to about 0° C. so as to liquefy the mercury vapor.

In step S410, the second collection container 140c collects the liquid mercury.

In step S412, a remaining gas from which the liquid mercury is removed is transported to the heat exchanging part 126c.

The filter 152 in the pump 150 filters the remaining gas from the heat exchanging part 126c.

Therefore, the recycling apparatus includes the heat exchanger 170 so as to decrease an energy consumption of the recycling apparatus.

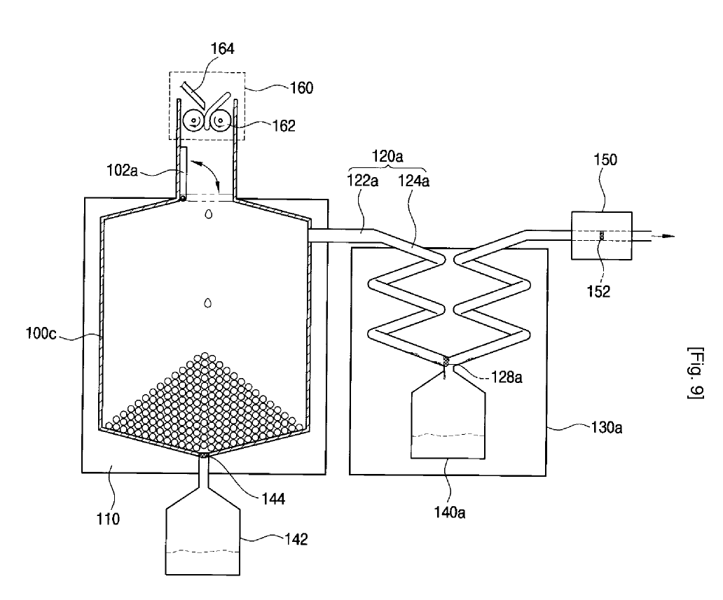

FIG. 8 is a cross-sectional view showing a recycling apparatus in accordance with another exemplary embodiment of the present invention.

The recycling apparatus of FIG. 8 is same as in FIG. 1 except for an inlet and a cover. Thus, the same reference numerals will be used to refer to the same or like parts as those described in FIG. 1 and any further explanation will be omitted.

Referring to FIG. 8, the recycling apparatus includes a breaker 160, a first collection container 10b, a cover 102b, a heater 110, a tubular unit 120a, a cooler 130a, a second collection container 140a and a pump 150.

The first collection container 100b is disposed under the breaker 160, and the first collection container 100b has a cylindrical shape. The first collection container 100b includes an upper opening, a first opening and a second opening. The upper opening corresponds to an upper portion of the first collection container 10b. The first and second openings correspond to a sidewall of the first collection container 10b. The first opening is disposed opposite to the second opening.

A connecting part 122a is connected to the sidewall of the first collection container 100b, and the connecting part 122a corresponds to the first opening. An inlet is disposed on a portion of the sidewall opposite to the collecting part 122a, and the inlet corresponds to the second opening. The inlet 104 may include a valve 104a. The valve 104a controls an amount of air that is provided from an exterior to the first collection container 100b.

The externally provided air maintains a pressure in the first collection container 100b.

The cover 102b is disposed on the first collection container 100b so as to open and close an upper opening corresponding to the upper portion of the first collection container 100b. The cover 102b is opened during breaking fluorescent lamps, and the cover 102b is closed during heating the broken pieces of the fluorescent lamps so as to prevent a backflow of gas having mercury. The cover 102b is closed, the cover 102b seals the upper opening corresponding to the upper portion of the first collection container 100b.

The pump 150 is connected to the condensing part 124a so as to aspirate gas from which a liquid mercury is removed.

When the pump 150 is operated, an air is provided from an exterior to the first collection container 100b through the inlet 104 so as to consecutively pass the first collection container 100b, the tubular unit 120a and the pump 150. A distance between the connecting part 122a and the inlet 104 is longer than a distance between the connecting part 122a and the upper opening corresponding to the upper portion of the first collection container 100b so that a time for the air to remain in the first collection container 100b is increased.

The remaining gas from which the liquid mercury is removed is ejected through the filter 152.

Therefore, the externally provided air is sufficiently heated in the first collection container 100b so as to increase a yield of the recycling apparatus.

FIG. 9 is a cross-sectional view showing a recycling apparatus in accordance with another exemplary embodiment of the present invention.

The recycling apparatus of FIG. 9 is same as in FIG. 1 except for a third collection container. Thus, the same reference numerals will be used to refer to the same or like parts as those described in FIG. 1 and any further explanation will be omitted.

Referring to FIG. 9, the recycling apparatus includes a breaker 160, a first collection container 100c, a cover 102a, a heater 110, a tubular unit 120a, a cooler 130a, a second collection container 140a, a third collection container 142 and a pump 150.

The first collection container 100c is disposed under the breaker 160. The first collection container 100c includes an upper opening, a bottom opening and a side opening. The upper opening corresponds to an upper surface of the first collection container 100c, and the bottom opening corresponds to a bottom surface of the first collection container 100c. The side opening is formed in a sidewall of the first collection container 100c. The first collection container 100c has a cylindrical shape. A size of the upper opening corresponding to the upper surface is larger than a size of the bottom opening corresponding to the bottom surface. The upper surface of the first collection container 100c has a conical shape so as to collect broken pieces of fluorescent lamps dropped from the breaker 160. The bottom surface of the first collection container 100c has a conical shape so as to collect a liquid mercury in the first collection container 100c.

The third collection container 142 is disposed under the first collection container 100c, and the third collection container 142 is connected to the first collection container 100c through a throughhole. A filter 144 is disposed between the first collection container 100c and the third collection container 142 so as to prevent the dropping of the broken pieces of the fluorescent lamps toward the third collection container 142.

When the heater 110 heats the first collection container 100c, a portion of the mercury on the broken pieces of the fluorescent lamps is evaporated so that the mercury vapor is guided into the tubular unit 120a, and another portion of the mercury on the broken pieces of the fluorescent lamps is liquefied so that the liquid mercury is guided into the third collection container 142.

Therefore, the recycling apparatus includes the third collection container 142 so that the liquid mercury in the first collection container 100c is collected in the third collection container 142.

Performance Test for Recycling Mercury

A recycling apparatus as shown in FIG. 1 was manufactured.

Here, the first collection container 100a had a cylindrical shape. A diameter and a height of the first collection container 100a were one meter. The breaker 160 broke two hundred CCFLs. A length of each of the CCFLs was thirty centimeters. A distance between the outer surfaces of the rollers 162 of the breaker 160 was five millimeters. The first collection container 100a received four kilograms of the broken pieces of the CCFLs. The broken pieces of the CCFLs included metal electrodes.

The cover 102a disposed on the first collection container 100a was closed, and the heater 110 heated the first collection container 100a at a temperature of 200° C. so as to form a gas containing a mercury vapor. The cooler 130a cooled the mercury vapor in the condensing part 124a down to a temperature of −10° C. While the first collection container 100a was heated, and the mercury vapor was cooled down to the above temperature, a pump 150 having the specific capacity of 201/min was operated for an hour.

436 mg of mercury was collected in the second collection container 140a. One CCFL included 2.5 mg of mercury so that the two hundred CCFLs included five hundred milligrams of mercury. Therefore, a yield of the recycling apparatus was 87%.

Another recycling apparatus as shown in FIG. 1 except for a size of a first collection container was manufactured.

Here, the first collection container had a cylindrical shape. A diameter and a height of the first collection container were 2.5 m. A breaker broke three thousand CCFLs. A length of each of the CCFLs was thirty centimeters. A distance between the outer surfaces of the rollers of the breaker was five millimeters. The first collection container received sixty kilograms of the broken pieces of the CCFLs. The broken pieces of the CCFLs included metal electrodes.

A cover disposed on the first collection container was closed, and a heater heated the first collection container at a temperature of 250° C. so as to form a gas containing a mercury vapor. A cooler cooled the mercury vapor in a condensing part down to a temperature of −10° C. While the first collection container was heated, and the mercury vapor was cooled down to the above temperature, a pump having the specific capacity of 201/min was operated for 2 hours.

6.7 g of mercury were collected in the second collection container. One CCFL included 2.5 mg of mercury so that three thousand CCFLs included 7.5 g of mercury. Therefore, a yield of the recycling apparatus was 89%.

Still another recycling apparatus as in FIG. 1 except for a size of a first connection container was manufactured.

Here, the first collection container had a cylindrical shape. A diameter and a height of the first collection container were four meters. A breaker broke twelve thousand CCFLs. A length of each of the CCFLs was thirty centimeters. A distance between the outer surfaces of the rollers of the breaker was five millimeters. The first collection container received 240 kg of the broken pieces of the CCFLs. The broken pieces of the CCFLs included metal electrodes.

A cover disposed on the first collection container was closed, and a heater heated the first collection container at a temperature of 300° C. so as to form a gas containing a mercury vapor. A cooler cooled the mercury vapor in a condensing part down to a temperature of −10° C. While the first collection container was heated, and the mercury vapor was cooled down to the above temperature, a pump having the specific capacity of 201/min was operated for 3 hours.

27.1 g of mercury were collected in the second collection container. One CCFL included 2.5 mg of mercury so that twelve thousand CCFLs included thirty grams of mercury. Therefore, a yield of the recycling apparatus was 90%.

Although not intending to be bound by theory, one possible reason as to why mercury is collected although the broken pieces of the fluorescent lamps are heated at a temperature no higher than the boiling point of mercury will be described hereinafter.

A process of evaporation in a closed container proceeds until number of molecules returning to a liquid is substantially equal to number of molecules escaping from the liquid, thereby forming an equilibrium between the liquid and a vapor. At this point, a condition of the vapor is represented by ‘saturated’. A pressure of the saturated vapor is represented by a saturation vapor pressure.

Since a molecular kinetic energy increases in proportion to a temperature, increased number of the molecules may escape from the liquid. The temperature at which the vapor pressure is equal to an atmospheric pressure is represented by ‘boiling point’.

A portion of a mercury in a predetermined volume is in a gas phase to form a mercury vapor, whereas a remaining portion of the mercury in the predetermined volume is in a liquid phase to form a liquid mercury at a roam temperature.

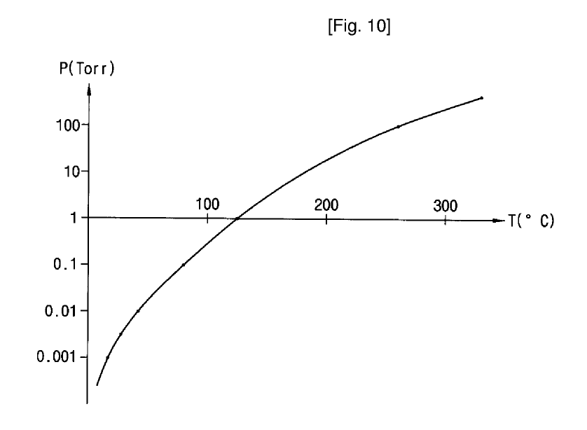

FIG. 10 is a graph showing a saturation vapor pressure of mercury according to a temperature, and table 1 represents the saturation vapor pressure of mercury according to the temperature.

TABLE 1

| | Temperature (° C.) | | | | | | | | | |
|---|---|---|---|---|---|---|---|---|---|---|
| | 16 | 25 | 46 | 80 | 125 | 200 | 250 | 260 | 300 | 330 |
| Saturation | 0.001 | 0.00185 | 0.01 | 0.1 | 1 | 13 | 70 | 100 | 220 | 400 |
| Vapor | | | | | | | | | | |
| Pressure | | | | | | | | | | |
| (Torr) | | | | | | | | | | |

Referring to FIG. 10 and Table 1, the saturation vapor pressures of mercury are 13 Torr, 70 Torr and 220 Torr at temperatures of 200° C., 250° C. and 300° C., respectively. 1 Torr corresponds to 1 mmHg. When the temperature is lower than 0° C., the saturation vapor pressure of mercury is negligible. When the temperature is higher than 356.66° C. that is the boiling point of mercury, all the mercury is in a gas phase that is a mercury vapor.

When the temperature is lower than 356.66° C., a portion of a mercury in a predetermined volume is the mercury vapor, whereas a remaining portion of the mercury in the predetermined volume is in a liquid phase that is a liquid mercury. That is, the portion of the mercury is in the gas phase that is the mercury vapor, although the temperature is lower than the boiling point of mercury. For example, when the temperature is 125° C., the saturation vapor pressure is 1 Torr, and the weight of the mercury vapor is about 8 g.

When the temperature of the saturated mercury vapor is decreased, a portion of the mercury vapor corresponding to the difference of the saturation vapor pressures is liquefied. For example, when the weight of the mercury vapor corresponding to a temperature of 260° C. is 10g/m³ that is less than the weight of the saturated mercury vapor, and the temperature of the mercury vapor is then decreased to 0° C., substantially all of the mercury vapor is liquefied.

A recycling apparatus according to the exemplary embodiment of the present invention guides the mercury vapor of a high temperature into a condensing part of a low temperature. That is, the vapor pressure in a first collection container is less than the saturation vapor pressure so that the mercury disposed on the broken pieces of the fluorescent lamps is constantly evaporated.

When the temperature in the condensing part is −10° C., the saturation vapor pressure of the condensing part is negligible so that substantially all the mercury vapor is liquefied, and the liquid mercury is collected in a second collection container.

### INDUSTRIAL APPLICABILITY

According to the present invention, broken pieces of fluorescent lamps are heated at a temperature no higher than a boiling point of mercury so that an energy consumption and a size of a recycling apparatus are decreased, and a probability for the recycling apparatus to malfunction may also be decreased. In addition, a pump includes a filter so that a remaining gas that passes through the filter may substantially not include mercury.

Furthermore, the recycling apparatus includes a condensing part and a heat exchanger so that a flow of the gas is a laminar flow, thereby decreasing an energy consumption.

Although the exemplary embodiments of the present invention have been described, it is understood that the present invention should not be limited to these exemplary embodiments but various changes and modifications can be made by one ordinary skilled in the art within the scope of the present invention as hereinafter claimed.

1. A method of recycling a fluorescent lamp, the method comprising:
heating broken pieces of fluorescent lamps at a temperature of about 100° C. to about 330° C. to form a gas containing a mercury vapor;
cooling the gas containing the mercury vapor at a temperature of about −38° C. to about 0° C. to form a liquid mercury; and
collecting the liquid mercury.

2. The method of claim 1, prior to forming of the gas containing the mercury vapor, further comprising breaking the fluorescent lamps.

3. The method of claim 2, wherein a size of each of the broken pieces of the fluorescent lamps is no larger than about 5 cm.

4. The method of claim 2, further comprising guiding a gas ejected from the broken pieces of the fluorescent lamps and particles of the broken pieces of the fluorescent lamps into the first collection container.

5. The method of claim 1, further comprising transporting the gas containing the mercury vapor from the broken pieces of the fluorescent lamps by a predetermined distance.

6. The method of claim 5, after the gas containing the mercury vapor is transported, further comprising pre-cooling the gas containing the mercury vapor using the cooled gas.

7. The method of claim 5, wherein a gas flow of the gas containing the mercury vapor corresponds to a laminar flow.

8. The method of claim 1, further comprising filtering a remaining gas from which the liquid mercury is removed.

9. A method of recycling a fluorescent lamp, the method comprising:
breaking fluorescent lamps using two rollers that rotate in opposite directions to each other;
collecting broken pieces of the fluorescent lamps under the rollers;
heating the collected broken pieces of the fluorescent lamps at a temperature of about 100° C. to about 300° C. to generate a gas containing a mercury vapor;
transporting the gas containing the mercury vapor to a condensing part having a spiral shape having a spiral axis that is substantially parallel with a direction of gravitational force;
cooling the gas in the condensing part at a temperature of about −20° C. to about 0° C. to liquefy the mercury vapor;
collecting the liquid mercury; and
filtering a remaining gas from which the liquid mercury is removed.

10. A method of recycling a fluorescent lamp, the method comprising:
breaking fluorescent lamps using two rollers that rotate in opposite directions to each other;
collecting broken pieces of the fluorescent lamps under the rollers;
heating the collected broken pieces of the fluorescent lamps at a temperature of about 100° C. to about 300° C. to generate a gas containing a mercury vapor;
transporting the gas containing the mercury vapor to a heat exchanger so as to pre-cool the transported gas;
transporting the pre-cooled gas to a condensing part having a spiral shape having a spiral axis that is substantially parallel with a direction of gravitational force;
cooling the gas in the condensing part at a temperature of about −20° C. to about 0° C. to liquefy the mercury vapor;
collecting the liquid mercury;
transporting a remaining gas from which the liquid mercury is removed to a heat exchanger; and
filtering the remaining gas that passes through the heat exchanger.

11. A recycling apparatus comprising:
a first collection container that collects broken pieces of fluorescent lamps;
a heater disposed adjacent to the first collection container to heat the first collection container to form a gas containing a mercury vapor;
a tubular unit that includes a connecting part connected to the first collection container and a condensing part connected to the connecting part to have a spiral shape having a spiral axis that is substantially parallel with a direction of gravitational force, the tubular unit gliding the gas containing the mercury vapor;
a cooler that surrounds the condensing part to cool the gas in the condensing part to liquefy the mercury vapor;
a second collection container disposed under the condensing part to collect the liquid mercury; and
a pump connected to the condensing part to aspirate the gas.

12. The recycling apparatus of claim 11, further comprising a breaker disposed over the first collection container to break the fluorescent lamps.

13. The recycling apparatus of claim 12, wherein the breaker comprises two rollers that rotate in opposite directions to each other.

14. The recycling apparatus of claim 13, wherein a distance between outer surfaces of the rollers is no greater than about 5 cm.

15. The recycling apparatus of claim 12, further comprising a blower that guides a gas ejected from the broken pieces of the fluorescent lamps and particles of the broken pieces of the fluorescent lamps toward the first collection container.

16. The recycling apparatus of claim 11, further comprising a cover disposed on the first collection container to open and close an upper opening of the first collection container.

17. The recycling apparatus of claim 16, wherein the cover seals the upper opening of the first collection container in case that the cover is closed, and the first collection container includes an inlet disposed at the first collection container opposite to the connecting part.

18. The recycling apparatus of claim 17, wherein the inlet comprises a valve controlling an amount of an air that is provided from an exterior the first collection container.

19. The recycling apparatus of claim 11, further comprising a third collection container disposed under the first collection container to collect the liquid mercury.

20. The recycling apparatus of claim 11, wherein the heater comprises an electric heater.

21. The recycling apparatus of claim 11, wherein the heater heats the first collection container at a temperature of about 100° C. to about 300° C.

22. The recycling apparatus of claim 11, wherein a diameter of the connecting part is greater than a diameter of the condensing part.

23. The recycling apparatus of claim 11, wherein the condensing part comprises two spiral tubes that are parallelly connected to form an U-shaped condensing part.

24. The recycling apparatus of claim 11, wherein the condensing part comprises four spiral tubes that are parallelly connected to form a W-shaped condensing part, and the recycling apparatus includes two collection containers disposed under the condensing part.

25. The recycling apparatus of claim 11, wherein the condensing part comprises ‘2n’ spiral tubes that are parallelly connected, the recycling apparatus includes ‘n’ collection containers disposed under the condensing part, and ‘n’ is a positive integer.

26. The recycling apparatus of claim 11, wherein the condensing part comprises a metal sieve disposed corresponding to the second collection container.

27. The recycling apparatus of claim 11, wherein the tubular unit further comprises a heat exchanging part disposed between the condensing part and the pump adjacent to the connecting part so as to exchange heat with the connecting part.

28. The recycling apparatus of claim 11, wherein the cooler cools the gas in the condensing part at a temperature of about −20° C. to about 0° C.

29. The recycling apparatus of claim 11, wherein the pump comprises a filter filtering the gas that passes through the pump.

30. The recycling apparatus of claim 29, wherein the filter further comprises an activated carbon or a cotton filter.

31. The recycling apparatus of claim 11, wherein a gas flow of the gas containing the mercury vapor corresponds to a laminar flow.

32. The recycling apparatus of claim 31, wherein a specific capacitor of the pump is no more than about 1001/min.

33. The recycling apparatus of claim 11, wherein the pump comprises a rotary pump.
